(19) United States
(12) Patent Application Publication
(10) Pub. No.: US 2016/0105215 A1
(43) Pub. Date: Apr. 14, 2016

(54) Crosstalk Cancellation Over Multiple Mediums

(71) Applicant: Futurewei Technologies, Inc., Plano, TX (US)

(72) Inventors: Xiang Wang, Shenzhen (CN); Haixiang Liang, Atherton, CA (US)

(21) Appl. No.: 14/883,371

(22) Filed: Oct. 14, 2015

Related U.S. Application Data
(60) Provisional application No. 62/063,854, filed on Oct. 14, 2014.

(51) Int. Cl. H04B 3/32; H04L 7/00; H04L 5/14; H04M 3/00

(52) U.S. Cl. CPC H04B 3/32; H04M 3/007; H04L 7/0008; H04L 5/1469

(57) ABSTRACT

A method of cancelling crosstalk including receiving, by a vector processor, a first signal from a first medium and a second signal from a second medium, wherein the first medium is different from the second medium, determining, using the vector processor, vectoring coefficients based on the first signal and the second signal received, cancelling, using the vector processor, the crosstalk from at least one of the first medium to the second medium and the second medium to the first medium using the vectoring coefficients determined, and transmitting or demodulating corrected signals following the cancellation of the crosstalk.

### CROSS-REFERENCE TO RELATED APPLICATIONS

The present application claims benefit of U.S. Provisional Patent Application No. 62/063,854 filed Oct. 14, 2014 by Xiang Wang, et al., and entitled, “Digital Subscriber Line and Home Network Cross Media Vectoring,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Digital subscriber line (DSL) is a family of technologies that provide internet access by transmitting digital data using a local telephone network which uses the Public switched telephone network (PSTN). In telecommunications marketing, the term DSL is widely understood to mean asymmetric digital subscriber line (ADSL), the most commonly installed DSL technology. DSL service is delivered simultaneously with wired telephone service on the same telephone line. This is possible because DSL uses higher frequency bands for data. On the customer premises, a DSL filter on each non-DSL outlet blocks any high frequency interference, to enable simultaneous use of the voice and DSL services.

G.fast is a DSL standard under development by the International Telecommunication Union's Telecommunication Standardization sector (ITU-T) to deliver speeds of 200 Megabits per second (Mbit/s) to 500 Mbit/s. In exceptional circumstances, speeds approach 1 Gigabit per second (Gbit/s). Generally, high speeds are only achieved over very short loops (e.g., shorter than 250 meters). It is a further development of technology used in very-high-bit-rate digital subscriber line 2 (VDSL2); however, it is optimized for shorter distances and is not likely to replace VDSL2 at longer distances. A formal specification has been drafted as ITU-T G.9701 entitled, “Fast Access to Subscriber Terminals (FAST)—Physical layer specification,” published December 2014, which is incorporated herein in its entirety by this reference.

Home Network (HN) is the common name for the home network technology family of standards developed under the ITU-T and Institute of Electrical and Electronics Engineers (IEEE). While the ITU-T developed G.hn, which is the common name for a home network technology family of standards, promoted by the Home Grid Forum and several other organizations, the IEEE developed standard P1901-2010 entitled, “IEEE Standard for Broadband over Power Line Networks: Medium Access Control and Physical Layer Specifications,” published December 2010, which is incorporated herein in its entirety by this reference, for broadband communication over power line within the home. The G.hn specifications define networking over power lines, phone lines and coaxial cables with data rates up to 1 Gbit/s.

As DSL networks get closer to customers, the convergence between DSL and HN becomes more significant. As the networks for DSL and HN get closer to each other, the crosstalk between them could cause problems to both. In the ITU-T, there are currently efforts to solve this problem through spectrum management or non-overlapped scheduled transmission between DSL and HN to mitigate the crosstalk between the two domains, which makes both the DSL and G.hn systems lose efficiency.

### SUMMARY

In one embodiment, the disclosure includes a method of cancelling far-end crosstalk (FEXT) including receiving, by a vector processor, a first signal from a first medium and a second signal from a second medium, wherein the first medium is different from the second medium, determining, using the vector processor, vectoring coefficients based on the first signal and the second signal received, cancelling, using the vector processor, the FEXT from at least one of the first medium to the second medium and the second medium to the first medium using the vectoring coefficients determined, and transmitting corrected signals following cancellation of the FEXT.

In another embodiment, the disclosure includes a method of cancelling near-end crosstalk (NEXT), including receiving, by a vector processor, a first signal from a first medium when a second signal is transmitted to a peer through a second medium, wherein the first medium is different from the second medium, determining, using the vector processor, vectoring coefficients based on the first signal and the second signal, cancelling, using the vector processor, the NEXT from the second medium to the first medium using the vectoring coefficients determined, and demodulating corrected signals on the first medium following cancellation of the NEXT.

In yet another embodiment, the disclosure includes an apparatus for cross medium vectoring including a vector processor operably coupled to a customer premises equipment (CPE) corresponding to a first medium and a domain access point (DAP) corresponding to a second medium, wherein the first medium is different from the second medium and the vector processor is configured to receive a first signal from the first medium and a second signal from the second medium, determine vectoring coefficients based on the first signal and the second signal received, and cancel interference from at least one of the first medium to the second medium and the second medium to the first medium using the vectoring coefficients determined, and a transmitter operably coupled to the vector processor and configured to transmit corrected signals following cancellation of the interference by the vector processor.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a chart of an embodiment of a frequency spectrum distribution between an access domain for G.fast and a home network domain for G.hn.

FIG. 2 is a schematic diagram of an embodiment of a network utilizing synchronized time division duplexing (TDD) framing in a FEXT vectoring case.

FIG. 3 is a schematic diagram of an embodiment of a network utilizing synchronized TDD framing in a NEXT vectoring case.

FIG. 4 is a schematic diagram of an embodiment of network configured to implement DS DSL transmission where both P2P and P2DAP may be used.

FIG. 5 is a schematic diagram of an embodiment of a network configured to implement DS DSL transmission where DAP2P may be used.

FIG. 6 is a schematic diagram of an embodiment of a network configured to implement US DSL transmission where DAP2P may be used.

FIG. 7 is a schematic diagram of an embodiment of a system configured to implement US DSL FEXT vectoring for a single DSL customer.

FIG. 8 is a schematic diagram of an embodiment of a system configured to implement US DSL FEXT vectoring for multiple DSL customers.

FIG. 9 is a schematic diagram of an embodiment of a system configured to implement DS DSL NEXT vectoring.

FIG. 10 is a schematic diagram of an embodiment of a network element configured to implement cross medium vectoring between two mediums.

FIG. 11 is a flowchart of an embodiment of a cross medium vectoring method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments utilizing time/clock synchronization between two mediums, such as DSL and HN, so that far-end crosstalk (FEXT) and near-end crosstalk (NEXT) cancellation schemes can be applied to remove the crosstalk between two systems. As will be more fully explained below, a vectoring technique is applied to reduce the crosstalk between the domains of the two mediums, for example, the crosstalk between a DSL domain and a Home Network (HN) domain. In an embodiment, the vectoring technique is implemented in a vector processor (VP) (a.k.a., a cross talk processor, cross medium processor, etc.) that is operably coupled to a customer premises equipment (CPE) in the DSL domain and a gateway (GW) configured as a domain access point (DAP) in the HN domain. The DSL domain and the HN domain are synchronized. The FEXT/NEXT channels are measured and are used to calculate the vectoring coefficients to reduce or eliminate crosstalk. In some embodiments, the vectoring coefficients can also be calculated directly through various kinds of channel estimation algorithms, for example, the coefficients can be calculated as the inverse of the estimated channel matrix.

In vectoring between a DSL and an HN domain or system, the DSL domain and the HN domain are synchronized in time and frequency. For example, synchronization may include, but is not limited to, synchronized duplexing, framing, sub-carrier spacing, symbols, sync symbols, preambles, and probe sequences. DSL signals from the CPE and HN signals from the GW are transmitted to the VP. By utilizing the vectoring coefficients, the VP performs cross medium/domain FEXT precoding, FEXT cancellation, and/or NEXT cancellation to significantly reduce the effects of crosstalk onto DSL signals and/or HN signals. In some embodiments, the VP estimates the FEXT/NEXT channel or the vectoring coefficients. The effects of crosstalk onto HN signal may also be reduced, for example, when FEXT vectoring is applied.

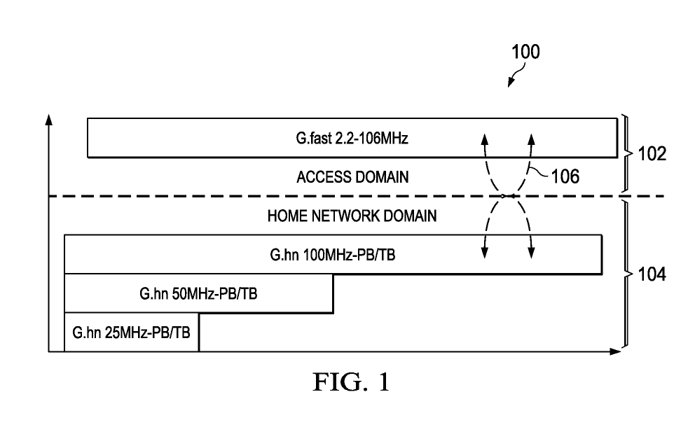

FIG. 1 is a chart 100 of an embodiment of a frequency spectrum distribution between an access domain 102 for G.fast and a home network domain 104 for G.hn. As shown, G.fast utilizes frequencies of between about 2.2 Megahertz (MHz) to about 106 MHz in the access domain. G.hn utilizes a frequency of about 100 MHz for twisted pair phone lines (MHz-TB) and about 100 MHz for electrical power lines (MHz-PB). Neighboring or overlapping frequencies between the access domain 102 and the home network domain 104 may induce undesirable crosstalk 106 between the domains. The G.hn architecture and protocols are described in further detail in ITU-T G.9960 entitled, “Unified high-speed wireline-based home networking transceivers—System architecture and physical layer specification,” originally published in December 2011 and as amended in July 2012, September 2012, and January 2014, in ITU-T G.9961 entitled, “Unified high-speed wireline-based home networking transceivers—Data link layer specification,” originally published April 2014, in ITU-T G.9962 entitled, “Unified high-speed wire-line based home networking transceivers—Management specification,” originally published July 2013 and as amended August 2013, in ITU-T G.9963 entitled, “Unified high-speed wireline-based home networking transceivers—Multiple input/multiple output specification,” originally published December 2011 and as amended January 2014 and April 2014, in ITU-T G.9964 entitled, “Unified high-speed wire-line based home networking transceivers—Power spectral density (PSD) specification,” originally published in December 2011, and in ITU-T G.9972 entitled, “Coexistence mechanism for wireline home networking transceivers,” originally published in June 2010, which are all incorporated herein by reference as if reproduced in their entirety.

Table 1 is an embodiment of a frequency spectrum distribution between a power-line baseband and a telephone-line baseband for home networking. As shown in Table 1, neighboring or overlapping frequencies between the power-line baseband and the telephone-line baseband may induce undesirable crosstalk between the basebands.

TABLE 1
An embodiment of a frequency spectrum distribution between a
power-line baseband and a telephone-line baseband for home networking

| Profile Name | Domain Type | Valid Bandplans |
|---|---|---|
| Low-complexity | Power-line baseband | 25 MHz-PB |
| profile | | |
| Standard profile | Power-line baseband | 50 MHz-PB, 100 MHz-PB |
| | Telephone-line | 50 MHz-TB, 100 MHz-TB |
| | baseband | |
| | Coax baseband | 50 MHz-CB, 100 MHz-CB |
| | Coax RF (CRF) | 50 MHz-CRF, 100 MHz-CRF, |
| | | 200 MHz-CRF |

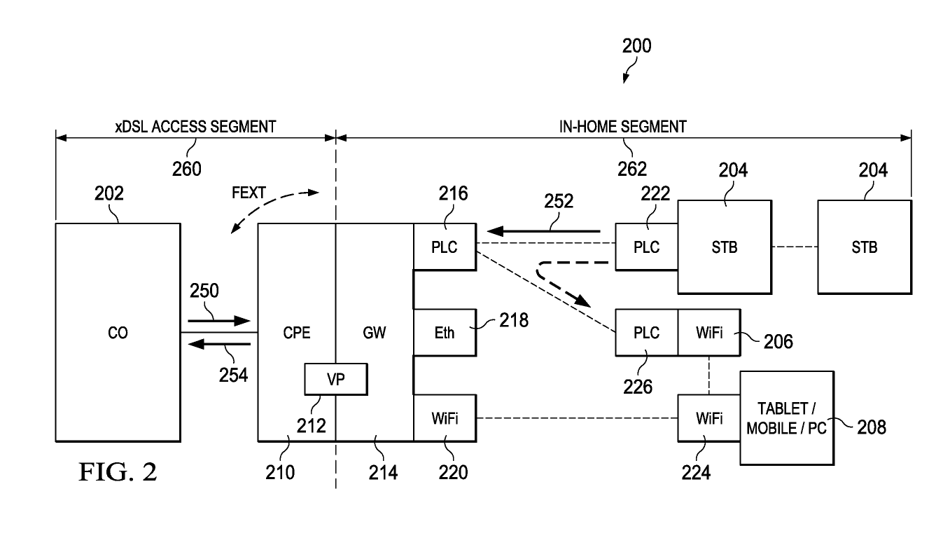

FIG. 2 is a schematic diagram of an embodiment of a network 200 utilizing synchronized TDD framing in a FEXT vectoring case. Network 200 may be configured as shown or in any other suitable configuration. Network 200 comprises an xDSL access segment 260 and an in-home segment 262. In an embodiment, the access segment 260 and the in-home segment 262 of FIG. 2 are similar to the access domain 102 for G.fast and a home network domain 104 for G.hn of FIG. 1. The xDSL segment 260 may also be referred to as the DSL domain. The xDSL segment 260 comprises a central office (CO) 202 operably coupled to a CPE 210. Depending on the supported standard, a DSL system may be denoted as an xDSL system where ‘x’ may indicate any DSL standard. For instance, ‘x’ may stand for ‘A’ in ADSL2 or ADSL2+ systems, ‘V’ in VDSL or VDSL2 systems, or ‘F’ in G.fast systems. The CO 202 is configured as an access node and may be implemented as an exchange, a DSL access multiplexer (DSLAM), a cabinet, a remote terminal, a distribution point, or any suitable network device for communicating DSL signals to the CPE 210. The CPE 210 is operably coupled to a VP 212 and to a GW 214 at the juncture between the xDSL access segment 260 and an In-home segment 262. The CPE 210 is configured to communicate signals (e.g., packets) between the CO 202 and other network devices. The CPE 210 may comprise a router, switch, a splitter, a DSL transceiver, or any other network device for communicating signals as would be appreciated by one of ordinary skill in the art upon viewing this disclosure. The VP 212 is operably coupled to the CPE 210 and the GW 214. VP 212 is configured to synchronize signals that are sent to or from the CPE 210 and the GW 214, to analyze the received signals or the channels that are used for communicating the signals, to determine vectoring coefficients for reducing crosstalk in the received signals, and to perform vectoring using the determined vectoring coefficients.

The in-home segment 262 comprises the GW 214 which is in signal communication with other network devices. The in-home segment 262 may also be referred to as an HN domain. In the HN domain, the GW 214 may be configured to operate or communicate with other network devices in a peer-to-peer mode, a centralized mode, and/or a unified mode. In a peer-to-peer mode, packets are directly exchanged between the GW 214 and another network device. In a centralized mode, the GW 214 is configured as a DAP and all packets are first transmitted to the GW 214 and then retransmitted to a destination network device. In a unified mode, the GW 214 is configured to support both the peer-to-peer mode and the centralized mode. The GW 214 may be configured for a peer-to-peer (P2P), peer-to-DAP (P2DAP), or DAP-to-peer (DAP2P) communications based on the mode the GW 214 is configured to operate in. Those skilled in the art will appreciate that when the GW 214 is configured in a centralized mode the xDSL access segment 260 and the in-home segment 262 use the same timing. The CPE 210 is connected to the GW 214 when it is configured as a DAP in the physical medium dependent (PMD) layer via the VP 212. In an embodiment, the GW 214 uses G.fast downstream (DS) symbol slots to receive a DSL signal and G.fast upstream (US) symbol slots to transmit a DSL signal. The data rate for an HN signal may be limited by the G.fast US available symbols.

For the DS FEXT vectoring, DS DSL signals and received HN signals at the GW 214 for both P2DAP and P2P are used by the VP 212. For DS NEXT vectoring, DS DSL signals and transmitted HN signals by the GW 214 for DAP2P are used by the VP 212. For US FEXT vectoring, US DSL signals and transmitting HN signals by the GW 214 are used by the VP 212. In addition, DS/US vectoring may adapt to the channel used by the GW 214. If the GW 214 is connected to peers via multiple lines, the GW 214 may use different transmitting/receiving channels (lines) for different peers at different symbol slots. In other words, the VP 212 adjusts vectoring coefficients accordingly. For CPE side channel estimation in the xDSL access segment 260, the GW 214 supports probe sequences to/from peers, peers support error feedback to the GW 214, and the CO 202 supports error feedback to VP 212.

The GW 214 is configured to route packets among the network devices that are operably coupled to the GW 214 or between the CPE 210 and the network devices that are operably coupled with the GW 214. The GW 214 is operably coupled to one or more network devices via ports. In FIG. 2, the GW 214 is operably coupled to a Power Line Communication port (PLC) 216, an Ethernet port (Eth) 218, and a wireless fidelity (Wifi) port or router 220. The PLC port 216 is operably coupled to a corresponding PLC port 222 of a Set Top Box (STB) 204. The STB 204 may be in communication with one or more other STBs 204. The PLC port 216 is also operably coupled to a PLC port 226 of a Wifi adapter 206. The Wifi adapter 206 is operably coupled with a Wifi port 224 or receiver of a computing device 208 (e.g., a tablet, a mobile phone, or a personal computer (PC)). The Wifi port 220 of the GW 214 is also operably coupled to the Wifi port 224 or receiver of the computing device 208. Examples of the computing device 208, include, but are not limited to, a tablet, a mobile phone, or a personal computer (PC).

For DS DSL communication, the in-home segment 262 may comprise a P2P configuration or P2DAP configuration between the GW 214 and one or more network devices. In the P2P case, the GW 214 is configured as a DAP and receives the DS DSL signal 250. Crosstalk from HN domain onto DS DSL signal 250 may be cancelled using the VP 212, for example, using FEXT cancellation, NEXT cancellation, or precoding. During DS DSL transmission, the VP 212 uses its received DS DSL signal 250 to perform FEXT cancellation. For example, the VP 212 is configured to analyze the received DS DSL signal 250 or the channel used for communicating the DS DSL signal 250, to determine vectoring coefficients for reducing crosstalk, and to perform FEXT cancellation using the vectoring coefficients. Crosstalk from DS DSL signal 250 onto a HN peer receiver should be small. In the P2DAP case, the FEXT between a DS DSL signal 250 and a HN signal 252 may be cancelled using VP 212.

For US DSL communication, the in-home segment 262 may comprise a DAP2P configuration between the GW 214 and one or more of the network devices. Crosstalk between the US DSL signal 254 and an HN signal 252 may be cancelled using VP 212. For example, during US DSL transmission, the VP 212, through the vectoring coefficients, precodes the US DSL signal 254 and the HN signal 252 (e.g., DAP2P signal) to cancel crosstalk.

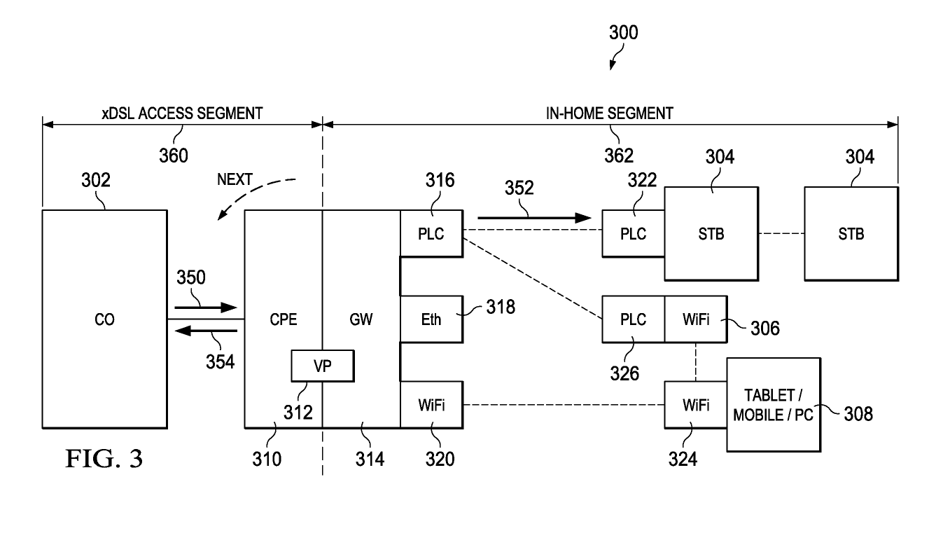

FIG. 3 is a schematic diagram of an embodiment of a network 300 utilizing synchronized TDD framing in a NEXT vectoring case. Network 300 comprises an xDSL access segment 360 and an in-home segment 362. Network 300 may be configured similar to network 200 in FIG. 2. For example, CO 302, CPE 310, GW 314, VP 312, PLC port 316, Ethernet port 318, Wifi port 320, PLC port 322, STBs 304, PLC port 326, Wifi adapter 306, Wifi port 324, and computing device 308 may be configured similar to CO 202, CPE 210, GW 214, VP 212, PLC port 216, Ethernet port 218, Wifi port 220, PLC port 222, STBs 204, PLC port 226, Wifi adapter 206, Wifi port 224, and computing device 208 in FIG. 2, respectively. Network 300 may be configured as shown or in any other suitable configuration.

Crosstalk from the in-home segment 362 (i.e., the HN domain) to xDSL access segment 260 (i.e., the DSL domain) may corrupt a DS DSL signal 350. The DS DSL signal 350 may be less corruptive to signals received in the in-home segment 362 due to attenuation. During DS DSL transmission, the in-home segment 362 may use various intervals for data transmission between the GW 314 and its peers when the GW 314 is configured as a DAP. Vectoring coefficients for NEXT or echo cancellation may be derived from transmitted DAP HN signals 352 and applied to received DS DSL signals 350 using VP 312.

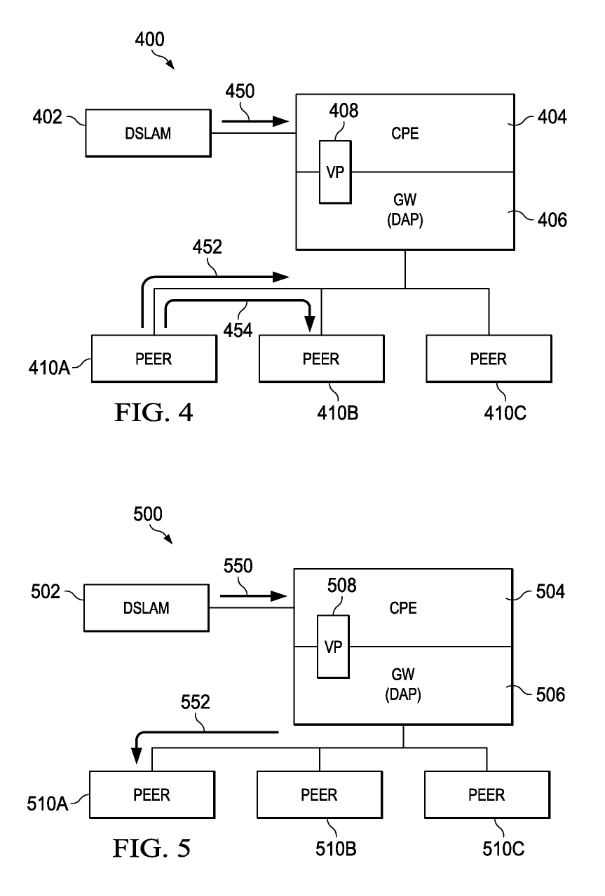

FIG. 4 is a schematic diagram of an embodiment of network 400 configured to implement DS DSL transmission where both P2P and P2DAP may be used. Network 400 comprises a DSLAM 402, a CPE 404, a GW 406, a VP 408, and peers 410A, 410B, and 410C. In an embodiment, the CPE 404, the GW 406, and the VP 408 of FIG. 4 are similar to the CPE 210, 310, the GW 214, 314, and the VP 212, 312 of FIGS. 2-3. Network 400 may be configured as shown or in any other suitable configuration.

The DSLAM 402 is in signal communication with CPE 404 and is configured as an access point for communicating signals to the CPE 404. The CPE 404 may be configured similar to CPE 210 in FIG. 2 or CPE 310 in FIG. 3. The CPE 404 is operably coupled to the VP 408 and the GW 406. The GW 406 may be configured similar to GW 214 in FIG. 2 or GW 314 in FIG. 3. The GW 406 is configured as a DAP and is in signal communication with peers 410A-410C. The GW 406 is configured to coordinate all of the peers 410A, 410B, and 410C and to allocate appropriate time slots for transmitting signals. The VP 408 may be configured similar to VP 212 in FIG. 2 or VP 312 in FIG. 3. The VP 408 is configured to receive signals from the CPE 404 and the GW 406, to analyze the received signals or the channels used for communicating the signals, and to determine vectoring coefficients for performing FEXT cancellation. Peers 410A-410C are each in signal communication with each other and with GW 406. Peers 410A-410C are each configured to send and receive HN signals, for example, HN signals 452 and 454. Examples of peers 410A-410C include, but are not limited to, an STB (e.g., STB 204 in FIG. 2 or STB 304 in FIG. 3) and a processing device (e.g., computing device 208 in FIG. 2 or computing device 308 in FIG. 3).

As an example, the DSLAM 402 sends a DSL signal 450 to the CPE 404 while the GW 406 receives an HN signal 452 and 454 from one or more of the peers 410A-410C. The VP 408 is configured to receive DSL signal 450 and the HN signal 452 from the CPE 404 and the GW 406, to analyze the received signals or the channels used for communicating the signals, and to determine vectoring coefficients based on the analysis for performing FEXT cancellation.

FIG. 5 is a schematic diagram of an embodiment of a network 500 configured to implement DS DSL transmission where DAP2P may be used. Network 500 comprises a DSLAM 502, a CPE 504, a GW 506, a VP 508, and peers 510A, 510B, and 510C. DSLAM 502, CPE 504, GW 506, VP 508, and peers 510A-510C are configured similar to DSLAM 402, CPE 404, GW 406, VP 408, and peers 410A-410C in FIG. 4, respectively. Network 500 may be configured as shown or in any other suitable configuration.

In FIG. 5, the DSLAM 502 sends a DSL signal 550 to the CPE 504 while the GW 506 sends an HN signal 552 to one or more of the peers 510A-510C. The VP 508 is configured to receive DSL signal 550 and the HN signal 552 from the CPE 504 and the GW 506, to analyze the received signals or the channels used for communicating the signals, and to determine vectoring coefficients based on the analysis for performing NEXT cancellation.

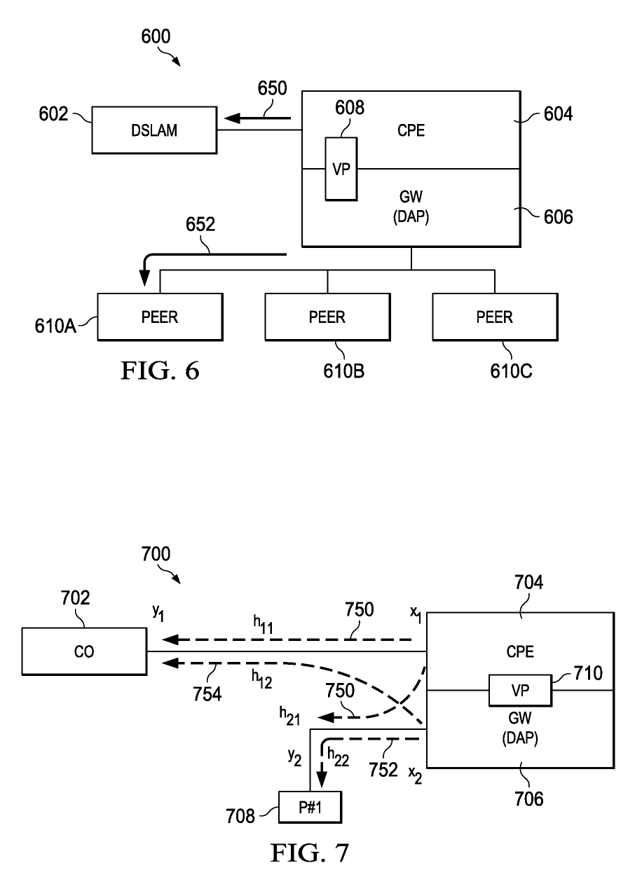

FIG. 6 is a schematic diagram of an embodiment of a network 600 configured to implement US DSL transmission where DAP2P may be used. Network 600 comprises a DSLAM 602, a CPE 604, a GW 606, a VP 608, and peers 610A, 610B, and 610C. DSLAM 602, CPE 604, GW 606, VP 608, and peers 610A-610C are configured similar to DSLAM 402, CPE 404, GW 406, VP 408, and peers 410A-410C in FIG. 4, respectively. Network 600 may be configured as shown or in any other suitable configuration.

In FIG. 6, the CPE 604 sends a DSL signal 650 to the DSLAM 602 while the GW 606 sends an HN signal 652 to one or more of the peers 610A-610C. The VP 608 is configured to receive DSL signal 650 and the HN signal 652 from the CPE 604 and the GW 606, to analyze the received signals or the channels used for communicating the signals, and to determine vectoring coefficients based on the analysis for performing precoding.

FIG. 7 is a schematic diagram of an embodiment of a system 700 configured to implement US DSL FEXT vectoring for a single DSL customer. The system 700 comprises a CO 702 that is in signal communication with a CPE 704. The CO 702 and the CPE 704 are configured to exchange (i.e., send and receive) DSL signals with each other. The CPE 704 is configured to send DSL signals with a VP 710. The VP 710 is operably coupled to the CPE 704 and a GW 706. In an embodiment, the CPE 704, the GW 706, and the VP 710 of FIG. 7 are configured similar to the CPE 404, GW 406, and VP 408 in FIG. 4. The VP 710 is configured to synchronize signals that are sent to or from the CPE 704 and the GW 706, to analyze the received signals or channels communicating the signals, to determine vectoring coefficients for reducing crosstalk in the received signals, and to perform vectoring using the vectoring coefficients. The GW 706 is configured as a DAP and is in signal communication with a port (P#1) 708 of the DSL user. The GW 706 is configured to exchange (i.e., send and receive) HN signals with the port 708 of the DSL user.

In FIG. 7, the CPE 704 is configured to transmit a DSL signal to the CO 702 using a signal channel 750 and the GW 706 is configured to send an HN signal to the port 708 using a signal channel 752. During transmission of the DSL signal and the HN signal a first crosstalk channel 754 exists between the GW 706 and the CO 702 and a second crosstalk channel 756 exists between the CPE 704 and the port 708.

The crosstalk and vectoring between a DSL signal and an HN signal may be modeled as follows:

$${( \begin{matrix}{y}_{1} \\ {y}_{2}\end{matrix} )}_{\begin{matrix}⏟ \\ received signal\end{matrix}} = {( \begin{matrix}{f}_{1} & 0 \\ 0 & {f}_{2}\end{matrix} )}_{\begin{matrix}⏟ \\ FEQ\end{matrix}} \cdot ( {( \begin{matrix}{h}_{11} & {h}_{12} \\ {h}_{21} & {h}_{22}\end{matrix} )}_{\begin{matrix}⏟ \\ Channel\end{matrix}} \cdot {( \begin{matrix}{s}_{1} \\ {s}_{2}\end{matrix} )}_{\begin{matrix}⏟ \\ transmitted signal\end{matrix}} + {( \begin{matrix}{n}_{1} \\ {n}_{2}\end{matrix} )}_{\begin{matrix}⏟ \\ noise\end{matrix}} ) \approx ( \begin{matrix}1 & \frac{{h}_{12}}{{h}_{11}} \\ \frac{{h}_{21}}{{h}_{22}} & 1\end{matrix} ) \cdot ( \begin{matrix}{x}_{1} \\ {x}_{2}\end{matrix} ) \qquad ( 1 )$$

where y₁ represents a received DSL signal at the CO 702 from the CPE 704, y₂ represents a received HN signal at the port 708 of the DSL customer from the GW 706, f₁ and f₂ are frequency domain equalizer (FEQ) coefficients, h₁₁ is a channel between the CPE 704 and the CO 702, h₁₂ is a channel between the GW 706 and the CO 702, h₂₁ is a channel between the CPE 704 and the port 708 of the DSL customer, h₂₂ is a channel between the GW 706 and the port 708 of the DSL customer, x₁ is a transmitted DSL signal from the CPE 704 to the CO 702, x₂ is a transmitted HN signal from the GW 706 to the port 708 of the DSL customer, and n₁ and n₂ are noise coefficients. The FEQ coefficients are chosen such that f₁=1/h₁₁, f₂=1/h₂₂.

For synchronization pre-conditions, the timing is synchronized, sub-carrier spacing is synchronized, and duplexing and framing are synchronized. For simplicity, the noise terms in equation (1) are not considered for the following discussion. To cancel the crosstalk in the VP 710, the VP 710 can use a precoding as follows:

$${( \begin{matrix}{\tilde{x}}_{1} \\ {\tilde{x}}_{2}\end{matrix} )}_{\begin{matrix}⏟ \\ precoded signal\end{matrix}} = {( \begin{matrix}1 & \frac{{h}_{12}}{{h}_{11}} \\ \frac{{h}_{21}}{{h}_{22}} & 1\end{matrix} )}^{- 1} \cdot ( \begin{matrix}{x}_{1} \\ {x}_{2}\end{matrix} ) \qquad ( 2 )$$

where x₁ is a transmitted DSL signal from the CPE 704 to the CO 702, x₂ is a transmitted HN signal from the GW 706 to the port 708 of the DSL user, \tilde{x}₁ is a transmitted precoded DSL signal from the CPE 704 to the CO 702, \tilde{x}₂ is a transmitted precoded HN signal from the GW 706 to the port 708 of the DSL customer, h₁₁ is a channel between the CPE 704 and the CO 702, h₁₂ is a channel between the GW 706 and the CO 702, h₂₁ is a channel between the CPE 704 and the port 708 of the DSL customer, and h₂₂ is a channel between the GW 706 and the port 708 of the DSL customer.

The precoded signal will be transmitted synchronously so that crosstalk in received signal at the CO 702 and port 708 will be cancelled. The resulting received signals may be expressed as follows:

$$( \begin{matrix}{y}_{1} \\ {y}_{2}\end{matrix} ) = ( \begin{matrix}{f}_{1} & 0 \\ 0 & {f}_{2}\end{matrix} ) \cdot ( ( \begin{matrix}{h}_{11} & {h}_{12} \\ {h}_{21} & {h}_{22}\end{matrix} ) \cdot ( \begin{matrix}{\tilde{x}}_{1} \\ {\tilde{x}}_{2}\end{matrix} ) + ( \begin{matrix}{n}_{1} \\ {n}_{2}\end{matrix} ) ) \approx ( \begin{matrix}{x}_{1} \\ {x}_{2}\end{matrix} ) \qquad ( 3 )$$

where y₁ is a received DSL signal at the CO 702 from the CPE 704, y₂ is a received HN signal at the port 708 of the DSL customer from the GW 706, f₁ and f₂ are FEQ coefficients, h₁₁ is a channel between the CPE 704 and the CO 702, h₁₂ is a channel between the GW 706 and the CO 702, h₂₁ is a channel between the CPE 704 and the port 708 of the DSL customer, h₂₂ is a channel between the GW 706 and the port 708 of the DSL customer, \tilde{x}₁ is a transmitted precoded DSL signal from the CPE 704 to the CO 702, \tilde{x}₂ is a transmitted precoded HN signal from the GW 706 to the port 708 of the DSL customer, x₁ is a transmitted DSL signal from the CPE 704 to the CO 702, x₂ is a transmitted HN signal from the GW 706 to the port 708 of the DSL customer, and n₁ and n₂ are noise coefficients.

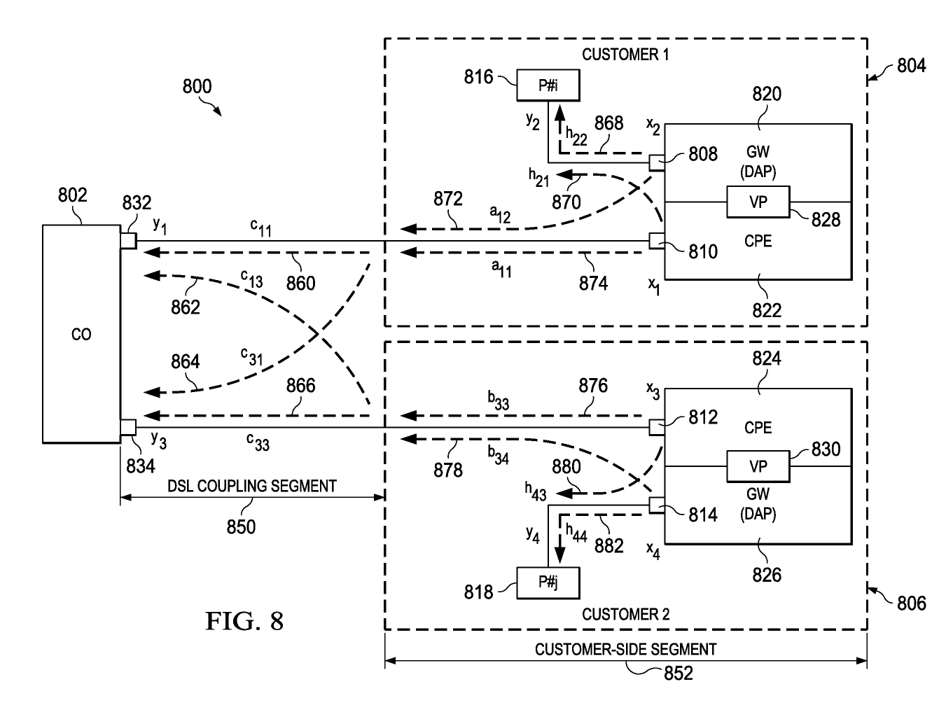

FIG. 8 is a schematic diagram of an embodiment of a system 800 configured to implement US DSL FEXT vectoring for multiple DSL customers. For illustrative purposes the system 800 comprises two customers 804 and 806. In other embodiments, system 800 may comprise any number of customers and the following formulas may be expanded accordingly. System 800 may be configured as shown or in any suitable configuration. The system 800 comprises a CO 802 that is in signal communication with a first CPE 822 for the first customer 804 and a second CPE 824 for the second customer 806. In an embodiment, the first CPE 822 and/or the second CPE 824 of FIG. 8 are configured similar to the CPE 404 in FIG. 4. The CO 802 is configured to exchange (i.e., send and receive) DSL signals with the first CPE 822 and the second CPE 824 via a first port 832 and a second port 834 of the CO 802, respectively. The first CPE 822 is configured to send DSL signals to a first VP 828. In an embodiment, the first VP 828 is configured similar to the VP 408 in FIG. 4. The first VP 828 is operably coupled to the first CPE 822 and a first GW 820. In an embodiment, the first GW 820 is configured similar to the GW 406 in FIG. 4. The first VP 828 is configured to synchronize signals that are sent to or from the first CPE 822 and the first GW 820, to analyze the received signals or channels communicating the signals, to determine vectoring coefficients for canceling crosstalk in the received signals, and to perform crosstalk cancellation using the vectoring coefficients. The first GW 820 is configured as a DAP and is in signal communication with a first port (P#i) 816 of the first customer 804. The first GW 820 is configured to exchange (i.e., send and receive) HN signals with the first port 816.

Similarly, the second CPE 824 is configured to send DSL signals to a second VP 830. In an embodiment, the second VP 830 is configured similar to the VP 408 in FIG. 4. The second VP 830 is operably coupled to the second CPE 824 and a second GW 826. In an embodiment, the second GW 826 is configured similar to the GW 406 in FIG. 4. The second VP 830 is configured to synchronize signals that are sent to or from the second CPE 824 and the second GW 826, to analyze the received signals or channels communicating the signals, to determine vectoring coefficients for canceling crosstalk in the received signals, and to perform crosstalk cancellation using the vectoring coefficients. The second GW 826 is configured as a DAP and is in signal communication with a second port (P#j) 818 of the second customer 806. The second GW 826 is configured to exchange (i.e., send and receive) HN signals with the second port 818.

In FIG. 8, a plurality of channels (e.g., signal channels and crosstalk channels) may exist when transmitting DSL signals and/or HN signals. For example, a first channel 868 may be between the first GW 820 and the first port 816, a second channel 870 may be between the first CPE 822 and the first port 816, a third channel 872 may be between the first GW 820 and the CO 802 in the customer-side segment 852, a fourth channel 874 may be between the first CPE 822 and the CO 802 in the customer-side segment 852, a fifth channel 876 may be between the second CPE 824 and the CO 802 in the customer-side segment 852, a sixth channel 878 may be between the second GW 826 and the CO 802 in the customer-side segment 852, a seventh channel 880 may be between the second CPE 824 and the second port 818, an eight channel 882 may be between the second GW 826 and the second port 818, a ninth channel 860 may be between the first CPE 822 and the first port 832 of the CO 802 in the DSL coupling segment 850, a tenth channel 862 may be between the second CPE 824 and the first port 832 of the CO 802 in the DSL coupling segment 850, an eleventh channel 864 may be between the first CPE 822 and the second port 834 of the CO 802 in the DSL coupling segment 850, and a twelfth channel 866 may be between the second CPE 824 and the second port 834 of the CO 802 in the DSL coupling segment 850.

For a two customer case, a four-by-four (4×4) matrix channel can be modeled. In the channel, let port #1 be the DSL port 810 of the first customer 804, port #2 be the HN port 808 of the first customer 804, port #3 be the DSL port 812 of the second customer 806, and port #4 be the HN port 814 of the second customer 806. In the DSL coupling segment 850, there is only FEXT between the DSL ports 810 and 812. In the customer-side segment 852, there is no FEXT between the two different customers since there is no line coupling in this segment. The overall FFXT channel in 4×4 form then is as follows:

$${( \begin{matrix}{c}_{11} & 0 & {c}_{13} & 0 \\ 0 & 1 & 0 & 0 \\ {c}_{31} & 0 & {c}_{33} & 0 \\ 0 & 0 & 0 & 1\end{matrix} )}_{\begin{matrix}⏟ \\ DSL Coupling Segment FEXT Channel\end{matrix}} \cdot ( \begin{matrix}{\begin{matrix}{a}_{11} & {a}_{12} \\ {h}_{21} & {h}_{22}\end{matrix}}_{\begin{matrix}⏟ \\ Customer 1 side FEXT Channel\end{matrix}} & \begin{matrix}0 & 0 \\ 0 & 0\end{matrix} \\ \begin{matrix}0 & 0 \\ 0 & 0\end{matrix} & {\begin{matrix}{b}_{33} & {b}_{34} \\ {h}_{43} & {h}_{44}\end{matrix}}_{\begin{matrix}⏟ \\ Customer 2 side FEXT Channel\end{matrix}}\end{matrix} ) = ( \begin{matrix}{h}_{11} = {c}_{11} \cdot {a}_{11} & {h}_{12} = {c}_{11} \cdot {a}_{12} & {h}_{13} = {c}_{13} \cdot {b}_{33} & {h}_{14} = {c}_{13} \cdot {b}_{34} \\ {h}_{21} & {h}_{22} & 0 & 0 \\ {h}_{31} = {c}_{31} \cdot {a}_{11} & {h}_{32} = {c}_{31} \cdot {a}_{12} & {h}_{33} = {c}_{33} \cdot {b}_{33} & {h}_{34} = {c}_{33} \cdot {b}_{34} \\ 0 & 0 & {h}_{43} & {h}_{44}\end{matrix} ) = ( \begin{matrix}{h}_{11} & {h}_{12} & {h}_{13} & {h}_{14} \\ {h}_{21} & {h}_{22} & 0 & 0 \\ {h}_{31} & {h}_{32} & {h}_{33} & {h}_{34} \\ 0 & 0 & {h}_{43} & {h}_{44}\end{matrix} ) \qquad ( 4 )$$

where c₁₁ is the portion of the channel between the first port 832 of the CO 802 and the first CPE 822 in the DSL coupling segment 850, c₁₃ is the portion of the channel between the first port 832 of the CO 802 and the second CPE 824 in the DSL coupling segment 850, c₃₁ is the portion of the channel between the second port 834 of the CO 802 and the first CPE 822 in the DSL coupling segment 850, c₃₃ is the portion of the channel between the second port 834 of the CO 802 and the second CPE 824 in the DSL coupling segment 850, a₁₁ is the portion of the channel between the CO 802 and the first CPE 822 in the customer-side segment 852, a₁₂ is the portion of the channel between the CO 802 and the first GW 820 in the customer-side segment 852, b₃₃ is the portion of the channel between the CO 802 and the second CPE 824 in the customer-side segment 852, b₃₄ is the portion of the channel between the CO 802 and the second GW 826 in the customer-side segment 852, h₂₁ is the channel between the first CPE 822 and the first port 816 of the first customer 804, h₂₂ is the channel between the first GW 820 and the first port 816 of the first customer 804, h₄₃ is the channel between the second CPE 824 and the second port 818 of the second customer 806, and h₄₄ is the channel between the second GW 826 and the second port 818 of the second customer 806.

Note that h₁₄=c₁₃·b₃₄ and h₃₂=c₃₁·a₁₂, and therefore both are second-order FEXT. In general, a second-order FEXT is very weak. The above FEXT channel in Equation (4) can be approximated as:

$$( \begin{matrix}{h}_{11} & {h}_{12} & {h}_{13} & 0 \\ {h}_{21} & {h}_{22} & 0 & 0 \\ {h}_{31} & 0 & {h}_{33} & {h}_{34} \\ 0 & 0 & {h}_{43} & {h}_{44}\end{matrix} ) \qquad ( 5 )$$

and the received signals may be expressed as follows:

$$( \begin{matrix}{y}_{1} \\ {y}_{2} \\ {y}_{3} \\ {y}_{4}\end{matrix} ) = ( \begin{matrix}{f}_{1} & 0 & 0 & 0 \\ 0 & {f}_{2} & 0 & 0 \\ 0 & 0 & {f}_{3} & 0 \\ 0 & 0 & 0 & {f}_{4}\end{matrix} ) \cdot ( ( \begin{matrix}{h}_{11} & {h}_{12} & {h}_{13} & 0 \\ {h}_{21} & {h}_{22} & 0 & 0 \\ {h}_{31} & 0 & {h}_{33} & {h}_{34} \\ 0 & 0 & {h}_{43} & {h}_{44}\end{matrix} ) \cdot ( \begin{matrix}{x}_{1} \\ {x}_{2} \\ {x}_{3} \\ {x}_{4}\end{matrix} ) + ( \begin{matrix}{n}_{1} \\ {n}_{2} \\ {n}_{3} \\ {n}_{4}\end{matrix} ) ) \approx ( \begin{matrix}1 & \frac{{h}_{12}}{{h}_{11}} & \frac{{h}_{13}}{{h}_{11}} & 0 \\ \frac{{h}_{21}}{{h}_{22}} & 1 & 0 & 0 \\ \frac{{h}_{31}}{{h}_{33}} & 0 & 1 & \frac{{h}_{34}}{{h}_{33}} \\ 0 & 0 & \frac{{h}_{43}}{{h}_{44}} & 1\end{matrix} ) \cdot ( \begin{matrix}{x}_{1} \\ {x}_{2} \\ {x}_{3} \\ {x}_{4}\end{matrix} ) \qquad ( 6 )$$

where y₁ is the received DSL signal at the first port 832 of the CO 802, y₂ is the received HN signal at the first port 816 of the first customer 804, y₃ is the received DSL signal at the second port 834 of the CO 802, y₄ is the received HN signal at the second port 818 of the second customer 806, f₁˜f₄ are FEQ coefficients with fᵢ=1/hᵢᵢ, the channel elements hᵢⱼ correspond to those in Equation (4), x₁ is a transmitted DSL signal from the first CPE 822 to the CO 802, x₂ is a transmitted HN signal from the first GW 820 to the first port 816 of the first customer 804, x₃ is a transmitted DSL signal from the second CPE 824 to the CO 802, x₄ is a transmitted HN signal from the second GW 826 to the second port 818 of the second customer 806, and n₁-n₄ are noise coefficients.

To cancel crosstalk, the first VP 828 can use precoding as follows:

$${( \begin{matrix}{\tilde{x}}_{1} \\ {\tilde{x}}_{2}\end{matrix} )}_{\begin{matrix}⏟ \\ precoded signal\end{matrix}} = {( \begin{matrix}1 & \frac{{h}_{12}}{{h}_{11}} \\ \frac{{h}_{21}}{{h}_{22}} & 1\end{matrix} )}^{- 1} \cdot ( \begin{matrix}{x}_{1} \\ {x}_{2}\end{matrix} ) \qquad ( 7 )$$

where x₁ is a transmitted DSL signal from the first CPE 822 to the CO 802, x₂ is a transmitted HN signal from the first GW 820 to the first port 816 of the first customer 804, \tilde{x}₁ is a transmitted precoded DSL signal from the first CPE 822 to the CO 802, \tilde{x}₂ is a transmitted precoded HN signal from the first GW 820 to the first port 816 of the first customer 804, the channel elements hᵢⱼ correspond those in Equation (4). The second VP 830 can use a precoding as follows:

$${( \begin{matrix}{\tilde{x}}_{3} \\ {\tilde{x}}_{4}\end{matrix} )}_{\begin{matrix}⏟ \\ precoded signal\end{matrix}} = {( \begin{matrix}1 & \frac{{h}_{34}}{{h}_{33}} \\ \frac{{h}_{43}}{{h}_{44}} & 1\end{matrix} )}^{- 1} \cdot ( \begin{matrix}{x}_{3} \\ {x}_{4}\end{matrix} ) \qquad ( 8 )$$

where x₃ is a transmitted DSL signal from the second CPE 824 to the CO 802, x₄ is a transmitted HN signal from the second GW 826 to the second port 818 of the second customer 806, \tilde{x}₃ is a transmitted precoded DSL signal from the second CPE 824 to the CO 802, \tilde{x}₄ is a transmitted precoded HN signal from the second GW 826 to the second port 818 of the second customer 806, the channel elements hᵢⱼ correspond to those in Equation (4).

After precoding the received signals will be as follows:

$$( \begin{matrix}{y}_{1} \\ {y}_{2} \\ {y}_{3} \\ {y}_{4}\end{matrix} ) \approx ( \begin{matrix}1 & \frac{{h}_{12}}{{h}_{11}} & \frac{{h}_{13}}{{h}_{11}} & 0 \\ \frac{{h}_{21}}{{h}_{22}} & 1 & 0 & 0 \\ \frac{{h}_{31}}{{h}_{33}} & 0 & 1 & \frac{{h}_{34}}{{h}_{33}} \\ 0 & 0 & \frac{{h}_{43}}{{h}_{44}} & 1\end{matrix} ) \cdot ( \begin{matrix}{\tilde{x}}_{1} \\ {\tilde{x}}_{2} \\ {\tilde{x}}_{3} \\ {\tilde{x}}_{4}\end{matrix} ) = ( \begin{matrix}( \begin{matrix}1 & \frac{{h}_{12}}{{h}_{11}} \\ \frac{{h}_{21}}{{h}_{22}} & 1\end{matrix} ) & ( \begin{matrix}\frac{{h}_{13}}{{h}_{11}} & 0 \\ 0 & 0\end{matrix} ) \\ ( \begin{matrix}\frac{{h}_{31}}{{h}_{33}} & 0 \\ 0 & 0\end{matrix} ) & ( \begin{matrix}1 & \frac{{h}_{34}}{{h}_{33}} \\ \frac{{h}_{43}}{{h}_{44}} & 1\end{matrix} )\end{matrix} ) \cdot ( \begin{matrix}{( \begin{matrix}1 & \frac{{h}_{12}}{{h}_{11}} \\ \frac{{h}_{21}}{{h}_{22}} & 1\end{matrix} )}^{- 1} & \begin{matrix}0 & 0 \\ 0 & 0\end{matrix} \\ \begin{matrix}0 & 0 \\ 0 & 0\end{matrix} & {( \begin{matrix}1 & \frac{{h}_{34}}{{h}_{33}} \\ \frac{{h}_{43}}{{h}_{44}} & 1\end{matrix} )}^{- 1}\end{matrix} ) \cdot ( \begin{matrix}{x}_{1} \\ {x}_{2} \\ {x}_{3} \\ {x}_{4}\end{matrix} ) = ( \begin{matrix}\begin{matrix}1 & 0 \\ 0 & 1\end{matrix} & ( \begin{matrix}\frac{{h}_{13}}{{h}_{11}} & 0 \\ 0 & 0\end{matrix} ) \cdot {( \begin{matrix}1 & \frac{{h}_{34}}{{h}_{33}} \\ \frac{{h}_{43}}{{h}_{44}} & 1\end{matrix} )}^{- 1} \\ ( \begin{matrix}\frac{{h}_{31}}{{h}_{33}} & 0 \\ 0 & 0\end{matrix} ) \cdot {( \begin{matrix}1 & \frac{{h}_{12}}{{h}_{11}} \\ \frac{{h}_{21}}{{h}_{22}} & 1\end{matrix} )}^{- 1} & \begin{matrix}1 & 0 \\ 0 & 1\end{matrix}\end{matrix} ) \cdot ( \begin{matrix}{x}_{1} \\ {x}_{2} \\ {x}_{3} \\ {x}_{4}\end{matrix} ) \qquad ( 9 )$$

where y₁ is the received DSL signal at the first port 832 of the CO 802, y₂ is the received HN signal at the first port 816 of the first customer 804, y₃ is the received DSL signal at the second port 834 of the CO 802, y₄ is the received HN signal at the second port 818 of the second customer 806, the channel elements hᵢⱼ correspond to those in Equation (4), x₁ is a transmitted DSL signal from the first CPE 822 to the CO 802, x₂ is a transmitted HN signal from the first GW 820 to the first port 816 of the first customer 804, x₃ is a transmitted DSL signal from the second CPE 824 to the CO 802, x₄ is a transmitted HN signal from the second GW 826 to the second port 818 of the second customer 806, \acute{x}₁ is a transmitted precoded DSL signal from the first CPE 822 to the CO 802, \acute{x}₂ is a transmitted precoded HN signal from the first GW 820 to the first port 816 of the first customer 804, \acute{x}₃ is a transmitted precoded DSL signal from the second CPE 824 to the CO 802, and \acute{x}₄ is a transmitted precoded HN signal from the second GW 826 to the second port 818 of the second customer 806.

It holds in Equation (9) that

$$\frac{{h}_{34}}{{h}_{33}} = \frac{{b}_{34}}{{b}_{33}} and \frac{{h}_{12}}{{h}_{11}} = \frac{{a}_{12}}{{a}_{11}} ,$$

which both are equal-level far-end crosstalk (ELFEXT) to the DSL lines. Note that the HN line in general is not in the same quad with the DSL line. Therefore, taking the ELFEXT for normal twisted pair as a reference, the two ELFEXT values in general will be lower than −20 decibels (dB) up to 100 MHz. As a consequence, the following approximation holds:

$${( \begin{matrix}1 & \frac{{h}_{34}}{{h}_{33}} \\ \frac{{h}_{43}}{{h}_{44}} & 1\end{matrix} )}^{- 1} \approx ( \begin{matrix}1 & - \frac{{h}_{34}}{{h}_{33}} \\ - \frac{{h}_{43}}{{h}_{44}} & 1\end{matrix} ) AND {( \begin{matrix}1 & \frac{{h}_{12}}{{h}_{11}} \\ \frac{{h}_{21}}{{h}_{22}} & 1\end{matrix} )}^{- 1} \approx ( \begin{matrix}1 & - \frac{{h}_{12}}{{h}_{11}} \\ - \frac{{h}_{21}}{{h}_{22}} & 1\end{matrix} ) \qquad ( 10 )$$

where the channel elements hᵢⱼ correspond to those in Equation (4).

Consequently, the received signals are as follows:

$$( \begin{matrix}{y}_{1} \\ {y}_{2} \\ {y}_{3} \\ {y}_{4}\end{matrix} ) \approx ( \begin{matrix}\begin{matrix}1 & 0 \\ 0 & 1\end{matrix} & ( \begin{matrix}\frac{{h}_{13}}{{h}_{11}} & 0 \\ 0 & 0\end{matrix} ) \cdot ( \begin{matrix}1 & - \frac{{h}_{34}}{{h}_{33}} \\ - \frac{{h}_{43}}{{h}_{44}} & 1\end{matrix} ) \\ ( \begin{matrix}\frac{{h}_{31}}{{h}_{33}} & 0 \\ 0 & 0\end{matrix} ) \cdot ( \begin{matrix}1 & - \frac{{h}_{12}}{{h}_{11}} \\ - \frac{{h}_{21}}{{h}_{22}} & 1\end{matrix} ) & \begin{matrix}1 & 0 \\ 0 & 1\end{matrix}\end{matrix} ) \cdot ( \begin{matrix}{x}_{1} \\ {x}_{2} \\ {x}_{3} \\ {x}_{4}\end{matrix} ) = ( \begin{matrix}\begin{matrix}1 & 0 \\ 0 & 1\end{matrix} & \begin{matrix}\frac{{h}_{13}}{{h}_{11}} & - \frac{{h}_{13}}{{h}_{11}} \cdot \frac{{h}_{34}}{{h}_{33}} \\ 0 & 0\end{matrix} \\ \begin{matrix}\frac{{h}_{31}}{{h}_{33}} & - \frac{{h}_{31}}{{h}_{33}} \cdot \frac{{h}_{12}}{{h}_{11}} \\ 0 & 0\end{matrix} & \begin{matrix}1 & 0 \\ 0 & 1\end{matrix}\end{matrix} ) \cdot ( \begin{matrix}{x}_{1} \\ {x}_{2} \\ {x}_{3} \\ {x}_{4}\end{matrix} ) \qquad ( 11 )$$

where y₁ is the received DSL signal at the first port 832 of the CO 802, y₂ is the received HN signal at the first port 816 of the first customer 804, y₃ is the received DSL signal at the second port 834 of the CO 802, y₄ is the received HN signal at the second port 818 of the second customer 806, the channel elements hᵢⱼ correspond to those in Equation (4), x₁ is a transmitted DSL signal from the first CPE 822 to the CO 802, x₂ is a transmitted HN signal from the first GW 820 to the first port 816 of the first customer 804, x₃ is a transmitted DSL signal from the second CPE 824 to the CO 802, and x₄ is a transmitted HN signal from the second GW 826 to the second port 818 of the second customer 806.

By neglecting the second-order FEXT, we get:

$$( \begin{matrix}{y}_{1} \\ {y}_{2} \\ {y}_{3} \\ {y}_{4}\end{matrix} ) \approx ( \begin{matrix}1 & 0 & \frac{{h}_{13}}{{h}_{11}} & 0 \\ 0 & 1 & 0 & 0 \\ \frac{{h}_{31}}{{h}_{33}} & 0 & 1 & 0 \\ 0 & 0 & 0 & 1\end{matrix} ) \cdot ( \begin{matrix}{x}_{1} \\ {x}_{2} \\ {x}_{3} \\ {x}_{4}\end{matrix} ) \qquad ( 12 )$$

where yᵢ and xᵢ represent the same as in Equation (11), the hᵢⱼ represent the same as in Equation (4).

Removing the crosstalk from HN signals to DSL signals and the crosstalk from DSL signals to HN signals leaves the crosstalk between DSL ports un-cancelled. In other words:

$$( \begin{matrix}{y}_{1} \\ {y}_{3}\end{matrix} ) \approx ( \begin{matrix}1 & \frac{{h}_{13}}{{h}_{11}} \\ \frac{{h}_{31}}{{h}_{33}} & 1\end{matrix} ) \cdot ( \begin{matrix}{x}_{1} \\ {x}_{3}\end{matrix} ) \qquad ( 13 )$$

The previously discussed DSL CO vectoring technique can be applied to remove these un-cancelled crosstalk between the two DSL ports (i.e., the first port 816 and the second port 818). In the DS DSL FEXT vectoring case, the methodology is similar to the above US DSL FEXT vectoring case. The first VP 828 and the second VP 830 may be used to reduce the FEXT between DSL and HN significantly. For the multiple customer case, CO-side precoding can be applied in addition to the CPE-side FEXT cancellation to reduce the crosstalk between ports significantly.

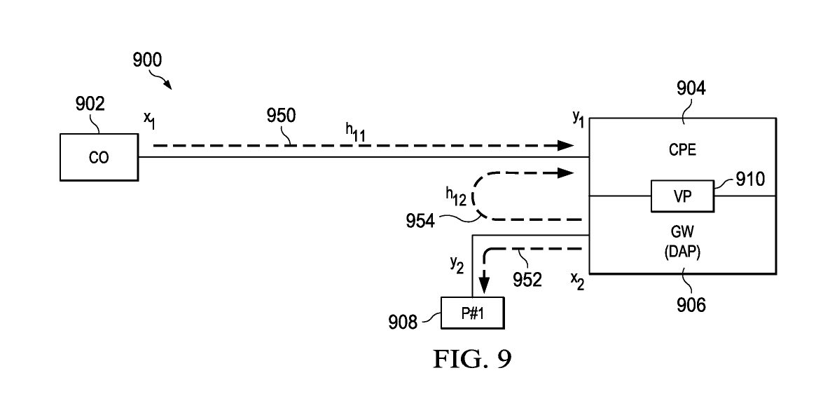

FIG. 9 is a schematic diagram of an embodiment of a system 900 configured to implement DS DSL NEXT vectoring. The system 900 comprises a CO 902 that is in signal communication with a CPE 904. The CO 902 and the CPE 904 are configured to exchange (i.e., send and receive) DSL signals with each other. The CPE 904 is configured to send DSL signals with a VP 910. The VP 910 is operably coupled to the CPE 904 and a GW 906. The VP 910 is configured to synchronize signals that are sent to or from the CPE 904 and the GW 906, to analyze the received signals or channels communicating the signals, to determine vectoring coefficients for canceling crosstalk in the received signals, and to perform crosstalk cancellation using the vectoring coefficients. The GW 906 is configured as a DAP and is in signal communication with a port (P#1) 908 of the DSL user. The GW 906 is configured to exchange (i.e., send and receive) HN signals with the port 908 of the DSL user.

In FIG. 9, the CPE 904 is receiving a DSL signal from the CO 902 using a signal channel 950 and the GW 906 is sending an HN signal to the port 908 using a signal channel 952. A NEXT channel 954 exists between the CPE 904 and the GW 906 during the transmission of the DSL signal and the HN signal. In this case, HN signal will add interference through the NEXT channel 954 to downstream DSL signal. NEXT cancellation can be applied to reduce the NEXT crosstalk into DSL signal significantly. Before NEXT cancellation the received signal is:

$${y}_{1} = {f}_{1} \cdot ( {r}_{1} + {n}_{1} ) = {f}_{1} \cdot ( {( {h}_{11} \cdot {x}_{1} + {h}_{12} \cdot {x}_{2} )}_{\begin{matrix}⏟ \\ received signal {r}_{1}\end{matrix}} + {n}_{1} ) \qquad ( 14 )$$

where yₗ is the received DSL signal at the CPE 904, f₁ is a FEQ coefficient with f₁=1/h₁₁, r₁ is a combined received signal, n₁ is an additive noise, h₁₁ is the channel between the CPE 904 and the CO 902, h₁₂ is the NEXT channel 954 between the CPE 904 and the GW 906, x₁ is the transmitted DSL signal by the CO 902, and x₂ is the transmitted HN signal by the GW 906. The NEXT cancellation then is:

r₁−h₁₂·x₂ (15)

where r₁ is the combined received signal, h₁₂ is the NEXT channel 954, and x₂ is the transmitted HN signal by the GW 906.

After performing NEXT cancellation, the NEXT crosstalk into DS DSL signal is removed. Note that in this case there is also potential crosstalk from the DS DSL signal into a DAP2P HN signal. The DS DSL signal is first attenuated in the twisted-pair before entering the HN domain, and therefore the potential crosstalk from the DS DSL signal into a DAP2P HN signal should be small. As a result, the crosstalk effect on the HN signal may be ignored.

In the P2DAP HN NEXT vectoring case, the US DSL signal will also introduce NEXT crosstalk into the P2DAP HN signals. A similar NEXT cancellation procedure may be used to remove NEXT crosstalk into the P2DAP HN signals. In this scenario, the P2DAP HN signal may introduce crosstalk into an US DSL signal, which may impact the US DSL data rate. Unless channel estimation shows a specific peer does not impact US DSL performance, that peer should be prevented from sending during US DSL transmission intervals.

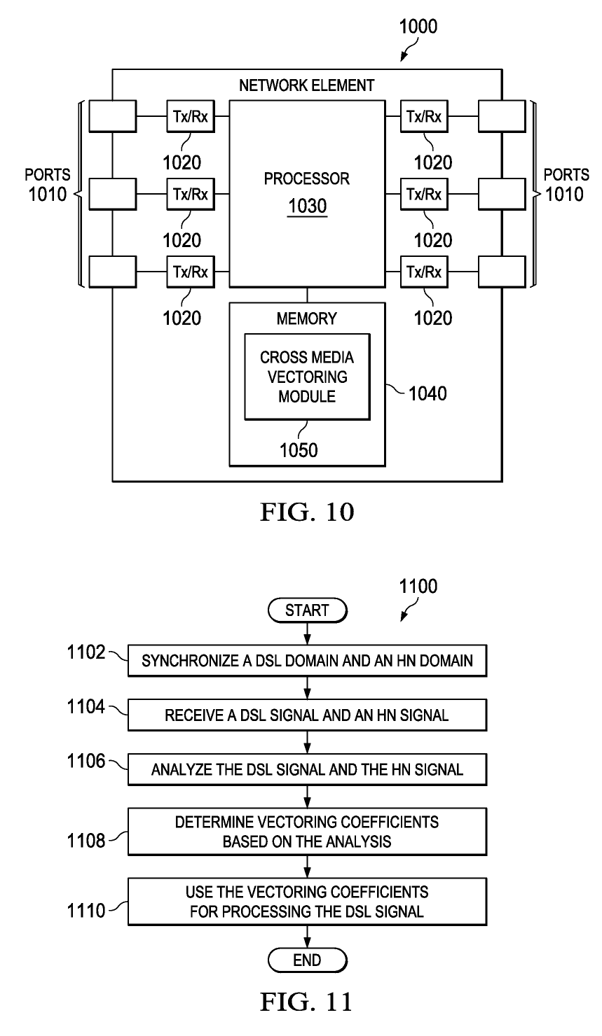

FIG. 10 is a schematic diagram of an embodiment of a network element 1000 configured to implement cross medium vectoring between two mediums. The network element 1000 may be suitable for implementing the disclosed embodiments. Network element 1000 may be any device (e.g., a CPE, a DAP, a GW, a modem, a DSL modem, a switch, a router, a bridge, a server, a client, a controller, a computer, etc.) that transports or assists with transporting data through a network, system, and/or domain. For example, network element 1000 may be implemented in a VP of a CPE or GW configured to participate in the vectoring process depicted in FIGS. 2-9 such as VP 212 in FIG. 2, VP 312 in FIG. 3, VP 408 in FIG. 4, VP 508 in FIG. 5, VP 608 in FIG. 6, VP 710 in FIG. 7, VP 828 or VP 830 in FIG. 8, or VP 910 in FIG. 9. Network element 1000 comprises ports 1010, transceiver units (Tx/Rx) 1020, a processor 1030, and a memory 1040 comprising a cross medium vectoring module 1050. Ports 1010 are coupled to Tx/Rx 1020, which may be transmitters, receivers, or combinations thereof. The Tx/Rx 1020 may transmit and receive data via the ports 1010. Processor 1030 is operably coupled to the Tx/Rx 1020 and is configured to process data. Memory 1040 is operably coupled to processor 1030 and is configured to store data and instructions for implementing embodiments described herein. The network element 1000 may also comprise electrical-to-optical (EO) components and optical-to-electrical (OE) components coupled to the ports 1010 and Tx/Rx 1020 for receiving and transmitting electrical signals and optical signals.

The processor 1030 may be implemented by hardware and software. The processor 1030 may be implemented as one or more central processing unit (CPU) chips, logic units, cores (e.g., as a multi-core processor), field-programmable gate arrays (FPGAs), application specific integrated circuits (ASICs), and digital signal processors (DSPs). The processor 1030 is in communication with the ports 1010, Tx/Rx 1020, and memory 1040.

The memory 1040 comprises one or more of disks, tape drives, or solid-state drives and may be used as an over-flow data storage device, to store programs when such programs are selected for execution, and to store instructions and data that are read during program execution. The memory 1040 may be volatile and non-volatile and may be read-only memory (ROM), random-access memory (RAM), ternary content-addressable memory (TCAM), or static random-access memory (SRAM). Cross medium vectoring module 1050 is implemented by processor 1030 to execute the instructions for implementing vectoring and crosstalk cancellation between two mediums. For example, the cross medium vectoring module 1050 is configured to reduce or eliminate crosstalk between DSL signals (e.g., G.fast signals) in an access domain and HN signals (e.g., G.hn signals) in a home network domain. For example, the cross medium vectoring module 350 is configured to provide instructions to receive the DSL signal and the HN signal from a CPE and a GW, to analyze the received signals or the channels used for communicating the signals, and to determine vectoring coefficients based on the analysis for performing precoding FEXT cancellation, or NEXT cancellation. The inclusion of cross medium vectoring module 1050 provides an improvement to the functionality of network element 1000. Cross medium vectoring module 1050 also effects a transformation of network element 1000 to a different state. Alternatively, cross medium vectoring module 1050 is implemented as instructions stored in the processor 1030.

FIG. 11 is a flowchart of an embodiment of a cross medium vectoring method 1100. The method 1100 may be performed by, for example, a vector processor similar to the vector processor 212, 312, 408, 508, 608, 710, 828, 830, 910, and 1050 in FIGS. 2-10. The method may be implemented when, for example, there is a need to remove or mitigate interference by one network upon another when the networks are using different technologies (e.g., DSL and home network, G.fast and G.hn, etc.) or same technologies but different mediums (e.g. HN using power line and HN using phone line at the same time). At step 1102, a DSL domain and a home network domain are synchronized by the vector processor. In an embodiment, a time or a clock is synchronized between the two domains.

At step 1104, a DSL signal and a home network signal are received by the vector processor. In an embodiment, the DSL signal is received from a CPE in a DSL domain and the home network signal is received from a DAP in a home network domain. The DSL signal may be received, for example, during downstream transmission in the DSL domain and the home network signal may be received during either P2P transmission or P2DAP transmission in the home network domain. The DSL and home network signals may also be received, for example, during upstream transmission in the DSL domain and DAP2P transmission in the home network domain, respectively.

At step 1106, the DSL signal and the home network signal or the channels carrying those signals are analyzed by the vector processor. At step 1108, the vectoring coefficients are determined based on the analysis. In an embodiment, one or more of the formulas noted above may be utilized in performing the analysis. At step 1108, the vectoring coefficients are used for processing the DSL signal. Such processing may permit FEXT cancellation, NEXT cancellation, echo cancellation, precoding, and so on. Therefore, corrected signals may be transmitted to one or more of the peer devices and/or received from one or more of the peer devices even though two different technologies are utilized during the transmission process.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of cancelling far-end crosstalk (FEXT), comprising:
receiving, by a vector processor, a first signal from a first medium and a second signal from a second medium, wherein the first medium is different from the second medium;
determining, using the vector processor, vectoring coefficients based on the first signal and the second signal received;
substantially cancelling, using the vector processor, the FEXT from at least one of the first medium to the second medium and the second medium to the first medium using the vectoring coefficients determined; and
transmitting corrected signals following the substantial cancellation of the FEXT.

2. The method of claim 1, wherein the first medium is digital subscriber line (DSL) and the second medium is home network, and wherein the vector processor uses time or clock synchronization between the DSL and the home network so that the corrected signals and one or more of symbols, sub-carriers, and frames are synchronized.

3. The method of claim 1, wherein the first medium is digital subscriber line (DSL), and wherein the vector processor is configured to use the first signal and the second signal to cancel the FEXT during downstream (DS) DSL transmission.

4. The method of claim 1, wherein the first medium is a digital subscriber line (DSL), and wherein the vector processor is configured to precode the first signal and the second signal using the vector processor to cancel the FEXT during upstream (US) DSL transmission.

5. The method of claim 1, wherein the second medium is a home network standards compliant medium, and wherein a gateway corresponding to the home network coordinates all peers and allocates time slots for transmitting the corrected signals.

6. The method of claim 1, wherein the first signal and the second signal are coordinated using synchronized time division duplexing (TDD).

7. The method of claim 1, wherein the vector processor is incorporated within at least one of a customer premises equipment (CPE) in a first domain corresponding to the first medium and a domain access point (DAP) in a second domain corresponding to the second medium.

8. The method of claim 1, wherein a customer premises equipment (CPE) in a first domain is coupled to a domain access point (DAP) in a second domain in a physical medium dependent (PMD) layer via the vector processor.

9. The method of claim 1, wherein a customer premises equipment (CPE) in a first domain uses downstream (DS) symbol slots corresponding to a second domain to receive signals and uses upstream (US) symbol slots corresponding to the second domain to transmit signals for vectoring.

10. The method of claim 1, wherein a customer premises equipment (CPE) corresponding to the first medium is configured to adjust vectoring to accommodate a domain access point (DAP) corresponding to the second medium that uses different channels between peers and the DAP at different symbol slots.

11. A method of cancelling near-end crosstalk (NEXT), comprising:
receiving, by a vector processor, a first signal from a first medium when a second signal is transmitted to a peer through a second medium, wherein the first medium is different from the second medium;
determining, using the vector processor, vectoring coefficients based on the first signal and the second signal;
substantially cancelling, using the vector processor, the NEXT from the second medium to the first medium using the vectoring coefficients determined; and
demodulating corrected signals following the substantial cancellation of the NEXT.

12. The method of claim 11, wherein the first medium is a digital subscriber line (DSL) and the second medium is a home network standards compliant medium, and wherein the vector processor uses time or clock synchronization between the DSL and the home network so that the corrected signals and one or more of symbols, sub-carriers, and frames are synchronized.

13. The method of claim 11, wherein at least one of a domain access point (DAP) and a customer premises equipment (CPE) is coupled to and includes the vector processor.

14. The method of claim 11, wherein a domain access point (DAP) corresponding to the second medium uses an interval for data transmission from the DAP to peers during a data reception corresponding to the first medium.

15. The method of claim 11, wherein cancellation of the NEXT is applied from the second signal transmitted by a domain access point (DAP) corresponding to the second medium to the first signal received by a customer premises equipment (CPE) corresponding to the first medium.

16. An apparatus for cross medium vectoring, comprising:
a vector processor operably coupled to a customer premises equipment (CPE) corresponding to a first medium and a domain access point (DAP) corresponding to a second medium, wherein the first medium is different from the second medium and the vector processor is configured to:
receive a first signal from the first medium and a second signal from the second medium;
determine vectoring coefficients based on the first signal and the second signal received; and
cancel interference from at least one of the first medium to the second medium and the second medium to the first medium using the vectoring coefficients determined; and
a transmitter operably coupled to the vector processor and configured to transmit corrected signals following cancellation of the interference by the vector processor.

17. The apparatus of claim 16, wherein the interference is far-end crosstalk (FEXT).

18. The apparatus of claim 16, wherein the first medium is a digital subscriber line (DSL) and the second medium is a home network standards compliant medium.

19. The apparatus of claim 18, wherein the DAP coordinates all peers in the home network and allocates time slots for transmission of the corrected signal.

20. The apparatus of claim 16, wherein the first signal and the second signal are coordinated using synchronized time division duplexing (TDD), and wherein the corrected signals and one or more of symbols, sub-carriers, and frames are synchronized.
